(19) United States
(12) Patent Application Publication
(10) Pub. No.: US 2020/0294033 A1
(43) Pub. Date: Sep. 17, 2020

(54) AUTOMATICALLY ASSIGNING CRYPTOGRAPHIC TOKENS TO CRYPTOCURRENCY WALLET ADDRESSES VIA A SMART CONTRACT IN RESPONSE TO ANALYSIS OF TRANSACTION DATA

(71) Applicant: BitScan Pty Ltd, Sydney (AU)

(72) Inventors: Robert WILSON, Sydney (AU); Jins Josvin KADUTHODIL, Sydney (AU)

(73) Assignee: BitScan Pty Ltd, Sydney (AU)

(21) Appl. No.: 16/354,592

(22) Filed: Mar. 15, 2019

(51) Int. Cl. G06Q 20/36; G06Q 20/06; G06Q 20/38

(52) U.S. Cl. CPC G06Q 20/3678; G06Q 20/0658; G06Q 2220/00; G06Q 20/3825; G06Q 20/3829

(57) ABSTRACT

A method comprising automatically assigning cryptographic tokens to cryptocurrency wallet addresses via a smart contract hosted on and executed by decentralised virtual machines of a decentralised network, storing received transaction history data in a transaction database; analysing and matching purchase transactions in the stored transaction history data by calculating a matching accuracy score; applying a predetermined reward rule on matching purchase transactions that have a calculated matching accuracy score above a predetermined matching threshold; wherein the predetermined reward rule comprising: calculating an amount of cryptographic tokens to be assigned at least based on an amount of the matching purchase transaction; and
assigning the calculated amount of cryptographic tokens to a cryptocurrency wallet address of a user via a blockchain transaction by digitally signing the blockchain transaction with a private key.

### FIELD OF THE INVENTION

The present invention relates to a method and system for automatically allocating cryptocurrency in response to analysis of transaction data obtained from external third parties.

### BACKGROUND TO THE INVENTION

Blockchain technology was developed as a way of providing a publicly transparent and decentralized ledger that is configured to track and store digital transactions in a publicly verifiable, secure, and hardened manner to prevent tampering or revision.

Blockchain infrastructure enables data to be decentralized and distributed across multiple devices in a peer to peer network. Typical blockchain infrastructure has design constraints that function to limit or slow down the amount of data that can be posted to a distributed ledger. The smaller the amount of data, the lower the latency period between posting and verification and authentication of the data.

The term “smart contract” refers to a computerised transaction protocol that defines complex transaction logic and facilitates cross-organisational workflow including storage of data, data access permissions, ordered workflow and computation. Smart contracts are self executing software codified agreements between known parties that have all of the relevant covenants written in software code, and settle automatically, depending on future signatures or trigger events. By leveraging blockchain technologies, smart contracts that are appended to the blockchain, cannot be revoked, denied, or reversed, since decentralized execution removes them from the control of any one party.

Distributed cryptocurrencies are not controlled by any central authority, but rather by a distributed network of computing devices that operate to confirm transfers of the cryptocurrency between payers and payees. Examples include Bitcoin or Ether. Each payer and payee has a unique cryptocurrency wallet address which is a pseudonymous public address (public key). To prove that the payer or payee owns cryptocurrency wallet address, they use a private key which is a 256-bit long random number unique related to the public address, in order to sign transactions to transfer cryptocurrency from their cryptocurrency wallet address to another address.

Cryptocurrencies comprise blockchain tokens which are fungible stores of value that can be transferred in a peer-to-peer manner between users without an intermediary, may be used to pay for usage/securing the blockchain network, and may incentivise contribution to the blockchain network. In some forms, blockchain tokens are smart-contract based and reside in the application layer of the blockchain technology stack and function to transfer value from the application layer to the protocol layer. The blockchain technology stack comprises many middle layer protocols to power applications because each application or business domain requires its own unique token economics design and therefore a separate unique protocol to incorporate the token economics of each application.

Confirming transactions on a blockchain network can be slow (e.g. hours or days for unprocessed transactions) and expensive, both problems arising in part due to market driven forces. Miners can select which transactions (e.g. ones that pay well) from a transaction pool to insert into a block they are mining (i.e. block creation) where such payment is received as an additional reward if the miner is successful in generating and writing a block including that transaction to the blockchain.

A blockchain requires a mechanism allowing to decide which chain of blocks is valid and to ensure there are no double-spending (e.g. sending the same cryptocurrency to different parties in separate chains). One approach is a leased proof of stake (LPoS) mechanism which allows any user to transfer their technical capacities for mining and receive rewards at the same time increasing network security. In a typical proof of stake system, the creator of a new block (i.e. a miner) is randomly selected, with greater amounts of stake increasing the likelihood of adding a block to the chain. There is no block reward, thus, the miners take the transaction fees. Proof of stake requires less energy consumption compared to proof of work. In a leased proof of stake, the miner has the ability to lease cryptocurrency from the wallet to different contractors which can pay a percentage as a reward. The larger the amount that is leased to a full node, the higher the chances of that full node being selected to produce the next block. If that full node is selected to produce the next block, the leaser will then receive a percentage of the transaction fee that is collected by the full node. In a Leased Proof-of-Stake environment, users can choose between running a full node or leasing their stake to a full node with receiving rewards. This system allows anyone to participate in the blockchain network maintenance.

A leasing transaction is created, for example by: id: ‘9q7X84wFuVvKqRdDQeWbtBmpsHt9SXFbvPPtUuKBVxxr’, sender: ‘3HgqG68qfeVz5dqbyvqnxQceFaH49xmGvUS’, fee: 0.001, amount: 10, recipientAddress: ‘3HQanDJhZSsSLbCjTCsMYpPvuj2ieGwKwQ9’ timestamp: 46305781705234713

To cancel the above example of a leasing transaction: sender: ‘3HgqG68qfeVz5dqbyvqnxQceFaH49xmGvUS’, leaseId: ‘9q7X84wFuVvKqRdDQeWbtBmpsHt9SXFbvPPtUuKBVxxr’

Loyalty programs traditionally generate 12 to 18% additional revenue to the merchants compared to a customer base that has in no loyalty schemes. The estimated worth of the US loyalty rewards industry is $65B. Forecasting show that this would grow up to $100B by 2020. Loyalty programs such as frequent flier miles are corporate issued currencies. One goal of a loyalty program is to increase the quantity of repeated business from a particular client. However, when a company is under pressure to generate additional revenue, one of the easiest solutions for them to cut costs and liabilities is to reduce the value of any new and outstanding loyalty/reward points. In the event the company becomes insolvent, the value of those loyalty/reward points are worthless. Accenture has commented that loyalty programs typically cost more and deliver less than many stakeholders in a loyalty system realise. This is due in part to the incompleteness and complexity of existing loyalty programs for both users and merchants to adopt.

Currently, physical plastic cards (e.g. incorporating a magnetic stripe and/or chip) are required to be carried and presented at the time of purchase to earn loyalty points which is onerous and detracts from a pleasant and frictionless user experience. In recent times, virtual/digital loyalty cards are another option and although they avoid the need for a physical card they still require the user to present their smart phone for displaying a screen of an app to the merchant for scanning to record the customer's details associating it with a transaction for earning loyalty points.

### SUMMARY OF THE INVENTION

The inventive concept arises from a recognition that a desirable optimal user experience reduces cognitive load by eliminating the requirement to present a loyalty card (whether physical or virtual/digital) at the point of sale or by subsequently submitting a time-consuming claim for missing loyalty points. It is another recognition that an automated process, which does not interfere with a user's conventional purchasing behaviour, which calculates and assigns a reward based on eligible transactions is desirable. It is another recognition that the value of rewards provided to users is independent from control by a central authority (i.e. a specific merchant). It is another recognition that rewards owned by users are stored in a secure, distributed and pseudonymous manner, the recording of the ownership of rewards is immutable and the transfer (including redemption/exchange) of rewards is executed in near real-time without significant cost.

In one aspect, there is provided a method comprising automatically assigning cryptographic tokens to cryptocurrency wallet addresses via a smart contract hosted on and executed by decentralised virtual machines of a decentralised network. The method also comprises retrieving transaction history data for a linked account from a financial institution server using a stored security token to initiate a token-based authenticated session with the financial institution server. The linked account is an account of a user associated with a cryptocurrency wallet address. The method also comprises storing the received transaction history data in a transaction database. The method also comprises analysing and matching purchase transactions in the stored transaction history data by calculating a matching accuracy score. The method also comprises applying a predetermined reward rule on matching purchase transactions that have a calculated matching accuracy score above a predetermined matching threshold. The predetermined reward rule comprises calculating an amount of cryptographic tokens to be assigned at least based on an amount of the matching purchase transaction. The predetermined reward rule also comprises assigning the calculated amount of cryptographic tokens to the cryptocurrency wallet address of the user via a blockchain transaction by digitally signing the blockchain transaction with a private key.

The linked account is initially linked by: obtaining a first security token from a financial institution server having an account of the user; initiating a secure connection with the financial institution server using the security token by generating a security credential; generating a second security token from the financial institution server in response to the user inputting their login credentials for the financial institution server; and storing the second security token.

The matching accuracy score may be calculated by string matching a name of a merchant in the transaction history data with a record in database table of merchant names.

The matching accuracy score may be calculated by applying a predetermined set of pattern algorithms over metadata fields of the transaction history data to find string patterns unique to individual merchants.

The matching accuracy score may be calculated by performing inferencing on the transaction history data using a trained machine learning model performs, the trained model being trained using manually labelled training data and the transaction history data.

The matching accuracy score may be calculated by performing match analytics to determine a classification of a match if a regular expression is matched to the transaction history data with a 99%, 96% or 90% match rate, and if the match is below 90%, the transaction history data is quarantined in a separate storage for a manual labelling by an operator, wherein manually labelled transaction history data is input as manually classified training data for a training phase of the machine learning model to update the trained model.

The predetermined matching threshold may be 90%.

The predetermined reward rule may further comprise a base amount of cryptographic tokens payable irrespective of the amount of the matching purchase transaction.

The predetermined reward rule may further comprise a predetermined bonus amount of cryptographic tokens.

The predetermined reward rule may further comprise a bonus amount predetermined by a merchant identified from the matching purchase transaction.

One advantage of an embodiment of the present invention is that the system and method does not require merchants to develop and maintain their own infrastructure such as tracking or reconciliation in order to reward certain user behaviour as required in traditional computerised incentive/loyalty systems.

Other advantages and features according to the invention will be apparent to those of ordinary skill upon reading this application.

### BRIEF DESCRIPTION OF THE DRAWINGS

Embodiments of the invention will be described with respect to the figures, in which like reference numbers denote like elements and in which:

FIG. 1 is a system diagram of a system for automatically assigning cryptographic tokens to cryptocurrency wallet addresses via a smart contract hosted on and executed by decentralised virtual machines of a decentralised network with a process flow in accordance with a preferred embodiment of the present invention;

FIG. 2 is a process flow diagram of a tool bar installed within an Internet browser for collecting and aggregating user activity and automatically assigning cryptographic tokens to cryptocurrency wallet addresses via a smart contract hosted on and executed by decentralised virtual machines of a decentralised network;

FIG. 3 is an entity relationship diagram providing a high level overview of the stakeholders of the system of FIG. 1 and two screens of a mobile app that users may interact with the system of FIG. 1;

FIG. 4 is a flow chart for a transaction initiated via affiliate marketing;

FIGS. 5 to 9 are flow charts depicting a user registration process to register a user with the system of FIG. 1;

FIG. 10 is a flow chart depicting secure linking of a user's bank account to the system of FIG. 1; and

FIG. 11 is a flow chart depicting a matching rule to identify purchase transactions by a user, application of a reward rule to transfer of an amount of cryptocurrency to the user's cryptocurrency wallet address.

### DETAILED DESCRIPTION OF THE INVENTION

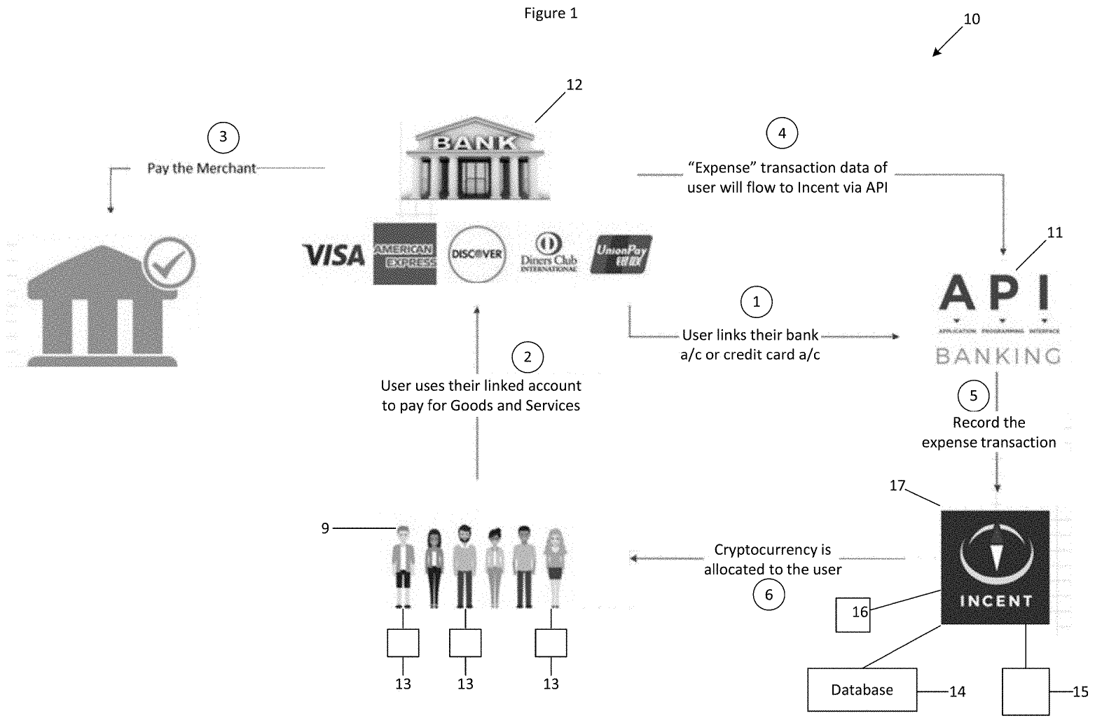

FIG. 1 is a block diagram illustrating a system 10 embodying the present invention. A public communications network, such as the Internet, is employed for messaging between servers 12, 17. Generally speaking, the servers 12, 17 may be any suitable computing, communications and/or processing appliances having the ability to communicate via the Internet, for example using connected web applications. Furthermore, while the exemplary system 10 comprises a single shared, insecure, network for communications between all processing devices and systems, embodiments of the invention may include other types of communications and/or transaction networks, such as logistical networks, private networks, virtual private networks (VPNs), cellular telephony networks, or a mix of these and/or other forms of communications systems.

It will therefore be understood that where the term ‘network interface’ is used throughout this specification, unless otherwise required by the context, it refers to a combination of physical hardware and/or network interface software (protocol stack) implementing the various communications protocols required to exchange information with other devices via one or more corresponding physical or virtual communications networks.

The processor is operably associated with a communications interface, via which it is able to communicate over the public network with the server 17.

In this specification, terms such as ‘processor’, ‘computer’, and so forth, unless otherwise required by the context, should be understood as referring to a range of possible implementations of devices, apparatus and systems comprising a combination of hardware and software. This includes single-processor and multi-processor devices and apparatus, including portable devices, desktop computers, and various types of server systems, including cooperating hardware and software platforms that may be co-located or distributed. Hardware may include conventional personal computer architectures, or other general-purpose hardware platforms. Software may include commercially available operating system software in combination with various application and service programs. Alternatively, computing or processing platforms may comprise custom hardware and/or software architectures. For enhanced scalability, computing and processing systems may comprise cloud computing platforms, enabling physical hardware resources to be allocated dynamically in response to service demands. While all of these variations fall within the scope of the present invention, for ease of explanation and understanding the exemplary embodiments described herein are based upon single-processor general-purpose computing platforms, commonly available operating system platforms, and/or widely available consumer products, such as desktop PCs, notebook or laptop PCs, smartphones, tablet computers, and so forth.

In particular, the term ‘processing unit’ is used in this specification (including the claims) to refer to any suitable combination of hardware and software configured to perform a particular defined task, such as generating and transmitting data, receiving and processing data, or receiving and validating data. Such a processing unit may comprise an executable code module executing at a single location on a single processing device, or may comprise cooperating executable code modules executing in multiple locations and/or on multiple processing devices.

Software components embodying features of the invention may be developed using any suitable programming language, development environment, or combinations of languages and development environments, as will be familiar to persons skilled in the art of software engineering. For example, suitable software may be developed using the C programming language, the Java programming language, the C++ programming language, the Go programming language, and/or a range of languages suitable for implementation of network or web-based services, such as JavaScript, HTML, PHP, ASP, JSP, Ruby, Python, and so forth. These examples are not intended to be limiting, and it will be appreciated that convenient languages or development systems may be employed, in accordance with system requirements.

In the exemplary system 10, the server 17 comprises a processor and implements a run-time server environment such as Node.js which is a JavaScript run-time environment that is executed by the processor as a standalone application. A V8 JavaScript runtime engine coverts JavaScript code into low-level machine code for faster execution by the processor without interpretation required. The processor is interfaced to, or otherwise operably associated with, a communications interface, one or more user input/output (I/O) interfaces, and local storage, which may comprise a combination of volatile and non-volatile storage. Non-volatile storage may include solid-state non-volatile memory, such as read only memory (ROM) flash memory, or the like. Volatile storage may include random access memory (RAM). The storage contains program instructions and transient data relating to the operation of the server 17. In some embodiments, the server 17 may include additional peripheral interfaces, such as an interface to high-capacity non-volatile storage, such as a hard disk drive, optical drive, and so forth.

The storage may contain program and data content relevant to the normal operation of the device. This may include operating system programs and data (e.g. associated with a Windows, Android, iOS, MacOS or Unix-based operating system), as well as other executable application software generally unrelated to the present invention. The storage also includes program instructions which, when executed by the processor instruct the server 17 to perform operations relating to an embodiment of the invention, for example such as are described below.

The server 17 comprises a processor. The processor is interfaced to, or otherwise operably associated with a non-volatile memory/storage device, which may be a hard disk drive, and/or may include a solid-state non-volatile memory, such as ROM, flash memory, or the like. The processor is also interfaced to volatile storage, such as RAM, which contains program instructions and transient data relating to the operation of the server 17.

In a conventional configuration, the storage device maintains known program and data content relevant to the normal operation of the server 17. For example, the storage device may contain operating system programs and data, as well as other executable application software necessary for the intended functions of the server 17. The storage device also contains program instructions which, when executed by the processor, instruct the server 17 to perform operations relating to an embodiment of the present invention, such as are described in greater detail below. In operation, instructions and data held on the storage device are transferred to volatile memory for execution on demand.

The processor is also operably associated with a communications interface in a conventional manner. The communications interface facilitates access to the data communications network.

In use, the volatile storage contains a corresponding body of program instructions transferred from the storage device and configured to perform processing and other operations embodying features of the present invention.

Referring to FIG. 1, a system 10 for automatically assigning cryptographic tokens to cryptocurrency wallet addresses via a smart contract hosted on and executed by decentralised virtual machines of a decentralised network 5 is provided. The system 10 comprises an application programming interface (API) 11 configured to retrieve transaction history data for a linked account from a financial institution server 12 using a stored security token to initiate a token-based authenticated session with the financial institution server 12. The linked account is an account of a user 9 associated with a cryptocurrency wallet address 13. The system 10 also comprises a transaction database 14 configured to store the received transaction history data. The transaction history data can be obtained via a push or pull mechanism via an API. The system 10 also comprises a server 17 executing a transaction analysis and matching module 15 configured to analyse and match purchase transactions in the stored transaction history data by calculating a matching accuracy score. The system 10 also comprises a rewards rule module 16 executed by the server 17 and is configured to apply a predetermined reward rule on matching purchase transactions that have a calculated matching accuracy score above a predetermined matching threshold. The predetermined reward rule comprises calculating an amount of cryptographic tokens to be assigned at least based on an amount of the matching purchase transaction. The predetermined reward rule comprises assigning the calculated amount of cryptographic tokens to the cryptocurrency wallet address 13 of the user 9 via a blockchain transaction by digitally signing the blockchain transaction with a private key.

At step 1, the user 9 provides their credentials for connecting to server 12 of their financial institution or bank where transactions are credited/debited. A secure token is provided by the bank.

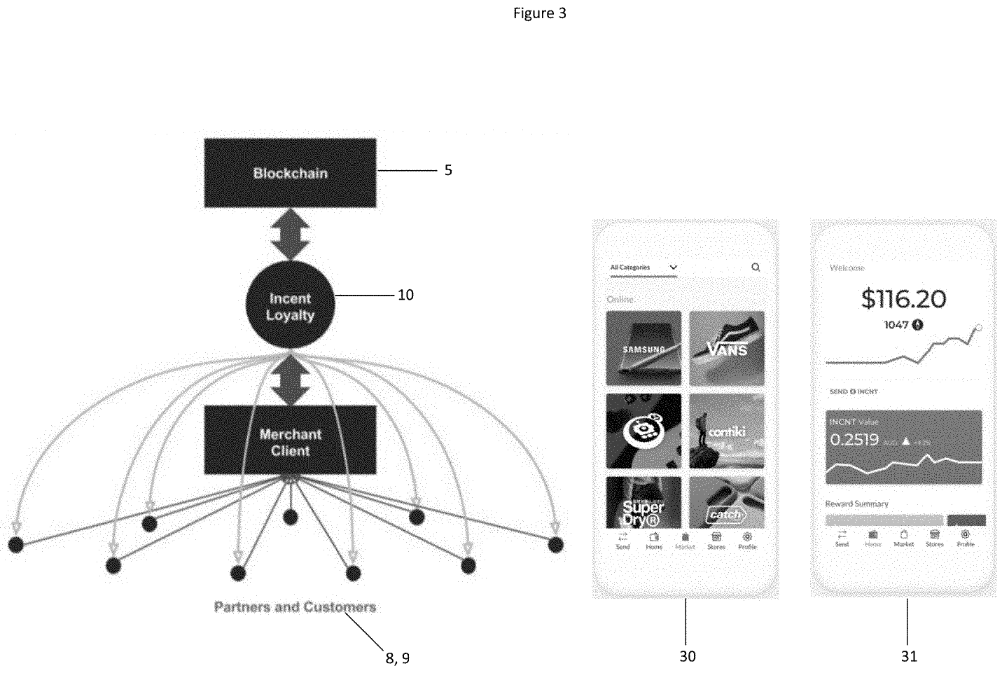

At step 2, a user 9 purchases goods or services from a merchant 8 as they normally would using their debit or credit card which is linked to their bank account from step 1 earlier. The merchant 8 may be a physical store or an online store. Referring to FIG. 3, a first screen 30 of a mobile app is provided which enables users 9 to conveniently identify and locate participating merchants 8 who may special promotions available that the users 9 may earn a cryptocurrency reward from. Another screen 31 of the mobile app 30 enables users 9 to view their present balance of cryptocurrency in their cryptocurrency wallet and the value of the cryptocurrency in a selected fiat currency, for example AUD$.

At step 3, the merchant is paid in the typical manner. The card issuing bank (the user's bank) essentially pays the acquiring bank (the merchant's bank) for its cardholder's purchases.

At step 4, on a periodic or scheduled basis, the API 11 retrieves the purchase transaction data records from the financial institution server 12 over a secure connection via the Internet.

At step 5, the retrieved transaction data records are stored in a transaction database 14. The transaction database 14 is configured to receive and store unstructured raw data and may be a key-value document database (NoSQL) such as Amazon DynamoDB. The raw data is processed using one or more of: regular expressions, text pattern recognition, inferencing by a trained machine learning model or prebuilt filtering software routines. The processing of the raw data transforms the raw data from unstructured form to structured form. The structured form of the transaction data is input into data fields of data records of a PostgreSQL database or similar SQL database. In the preferred embodiment of the present invention, there are multiple databases in data communication with each other and are either configured to store raw/unstructured data, or semi-processed or processed/structured data after processing by the software routines.

At step 6, after processing, merchant name matching and applying a predetermined reward rule from a set of reward rules, cryptocurrency is transferred from a cryptocurrency wallet address of the rewards provider to the cryptocurrency wallet address 13 of the user 9 via a smart contract.

Blockchain tokens (e.g. cryptocurrency) is accumulated from a large and increasing number of merchants to avoid any single point of failure. The merchants may be physical retail outlets or online/digital retailers. Blockchain tokens can be transferred (i.e. assigned) to other users or traded on an exchange market with dynamic pricing. Therefore the value of each blockchain token is freely determined by the entire market and the forces of supply and demand rather than a central authority.

Blockchain transaction records are signed using both a private key and a public key, the private key being that of a party transferring value and the public key being associated with a receiving address. The shared transaction ledger is typically publicly accessible via a website or other Internet-based platform.

Blockchain transaction records are verified by third parties carrying out what is known as “mining blocks”. Exemplary cryptocurrencies which make use of proof-of-work verification schemes, such as Secure Hash Algorithm 256 (SHA-256) or scrypt, are Bitcoin and Litecoin. An exemplary cryptocurrency system employing a combined proof-of-work/proof-of-stake verification scheme is PPCoin. The blockchain network may be the Waves blockchain network which is a two-tier architecture that enables the creation of a custom blockchain token. In the preferred embodiment, the custom blockchain token/cryptocurrency is referred to as INCNT. In the system 10, there is a hard-cap or maximum fixed quantity of INCNT permitted to exist, which is 46,016,599. The blockchain token is portable, transferable, convertible to other cryptocurrencies or fiat currency, may appreciate in value and does not expire. The Waves blockchain network includes a decentralised exchange to enable a trading pair of the custom blockchain token with another blockchain token compatible with Waves. This is advantageous to a centralised exchange because funds are stored in directly in users' wallets and users have autonomy and control over their transactions instead of a centralised exchange. There have been instances where a centralised exchange has been hacked and user accounts have been compromised.

The system 10 assists merchants to launch customizable loyalty programs with no additional costs or resources. The system 10 handles the distribution, storage, exchange, and creation of tokens (INCNT) and customised loyalty systems of individual merchants. Users 9 can spend the tokens with the original merchant or other participating merchants of the system 10. Users 9 can also sell their tokens in exchange for fiat currency or other digital currencies. This provides flexibility which the system 10 offers.

Smart contracts are executed on the blockchain network and the cost to execute the smart contract is typically a fixed fee. Lightweight and full nodes maintain the blockchain network. Lightweight nodes do not download the distributed ledger and depend on full nodes for transaction confirmations and the interactions on the network. A platform with a consensus protocol for nodes to prune full blocks not needed for mining facilitates trust between the lightweight and full nodes, and therefore the lightweight nodes use the current network state to establish simplified payment verification processes.

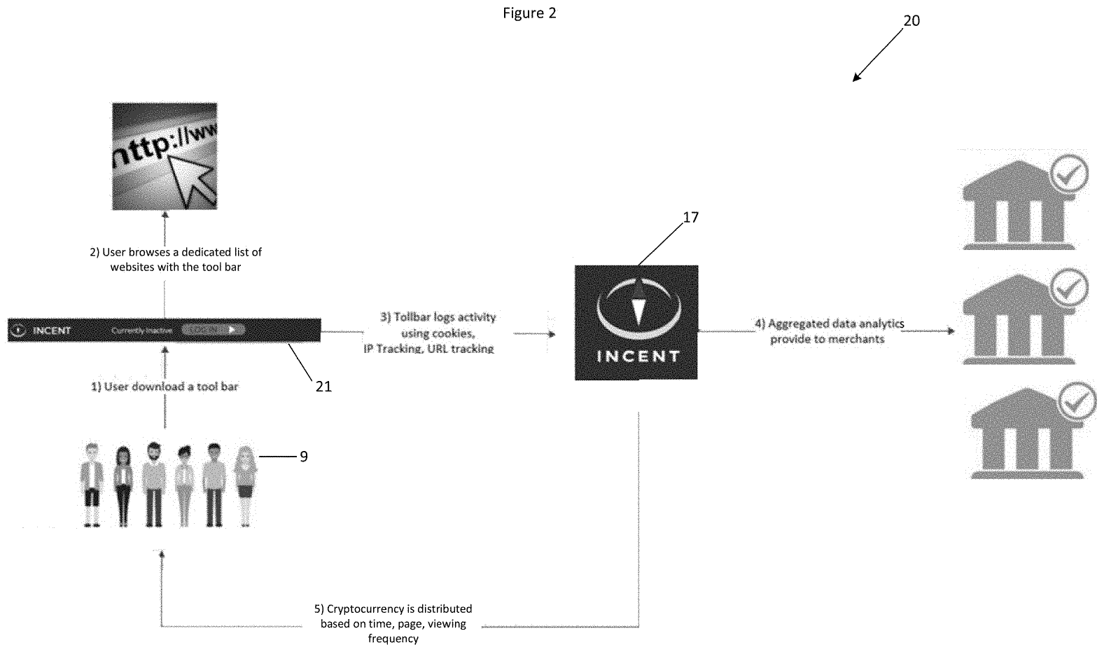

Referring to FIG. 2, a second system 20 for automatically assigning cryptographic tokens to cryptocurrency wallet addresses via a smart contract hosted on and executed by decentralised virtual machines of a decentralised network is provided. Rather than transferring cryptocurrency in relation to the trigger of purchasing a good or service, in the second system 20, cryptocurrency is transferred from a cryptocurrency wallet address of the rewards provider to the cryptocurrency wallet address 13 of the user 9 via a smart contract in response to user activity of the user 9 on the Internet, for example, visiting and interactions with certain web sites. The user 9 downloads and installs a toolbar 21 or a browser extension that presents a toolbar in their Internet browser application. The toolbar 21 comprises an Internet activity logger that records cookies, IP addresses and URLs and URL parameters. The users' unique cryptographic wallet address (that is, their public address) are associated to the Internet activity that the user undertakes. This Internet activity data including mouse clicks, mouse movement, scrolling, URL destinations, keystrokes, etc is recorded on a per minute basis. A URL whitelist may be used to reward only particular websites and specific webpages. The user will receive a reward in the form of cryptocurrency when both the whitelist URL and the allocated minimum time on the website is achieved. Minimum time on the website is calculated and measured by tracking one or more of the following activities: word count on the screen to calculate estimated read time, scroll behaviour based on word count, mouse movement, mouse clicks, time on site and hotspot tracking. The calculated minimum time is determined by software by parsing the HTML content of the web page. These measures are used to determine if the user has achieved a minimum time on the website.

A server 17 of the rewards provider receives data from Internet activity logger of the toolbar 21 that is identified to a particular user 9 (e.g. a UUID). This data may be transmitted periodically or in an unscheduled manner. The server 17 activates a matching module to identify visitations to certain websites and activity on certain websites that are eligible to receive a cryptocurrency distribution. A rewards rule module is executed by the server 17 and is configured to apply a predetermined reward rule on eligible Internet activity. For example, parameters of Internet activity that is interrogated includes time on a web site, frequency of visiting a web site within a period of time, input such as quantity of keystrokes or mouse activity on a web site. The predetermined reward rule assigns a predetermined quantity of cryptocurrency corresponding to the eligible Internet activity to be transferred from a cryptocurrency wallet address of the rewards provider to the cryptocurrency wallet address 13 of the user 9 via a smart contract.

The server 17 aggregates the Internet activity data from a plurality of user's Internet activity log generated by the toolbar 21 and anonymises the aggregated data. The aggregated data is processed according to data mining processes configured to identify anomalies, patterns and correlations within the aggregated data to generate reports including statistical tabular data and graphs. The generated reports are transmitted to merchants to assist them with decision making in relation to marketing strategy and product development, and to measure performance metrics and quantitative results of user testing experiments (i.e. A/B testing) that have modified user experience, pricing, copywriting or web site features.

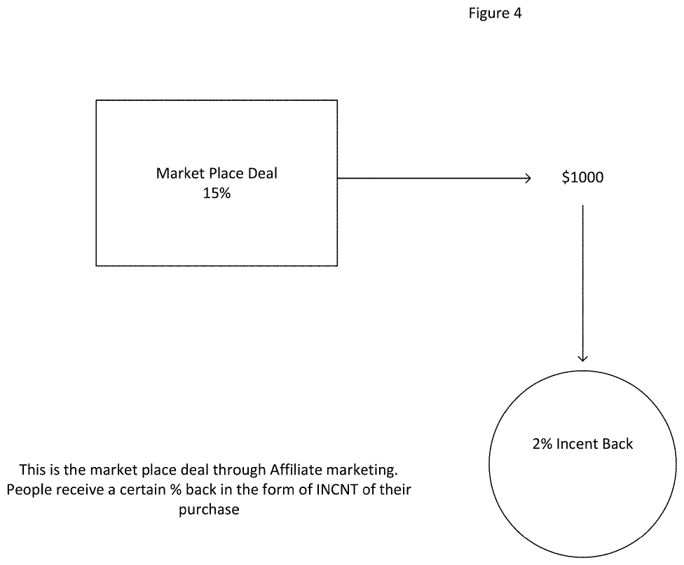

Referring to FIG. 4, a general non-technical overview from the perspective of the user on how they are rewarded with cryptocurrency based on their purchase transactions is depicted. The process is frictionless and does not require the user to perform any additional steps or modify the existing user experience of purchasing a product or service as the system 10 is hidden and operates in the background. The system 10 enables merchants to boost engagement and repeat business from users by incentivising customers with better than money rewards, at low cost and no risk. In this scenario, the system 10 functions as a loyalty-reward ecosystem and a community for all participating merchants and their users to discover each other and for users to earn rewards for eligible activities governed by a rules/deals software module including purchasing of products or services at participating merchants. Rule logic codified in the rules/deals module are characterised as persistent meaning there is no set time limit or additional limitations for users to earn rewards. Deal logic codified in the rules/deals module are characterised as time-based rewards which may have additional limitations such duration, specific time periods for particular days, and demographic limitations such as age, gender, particular store locations, etc. An advantage of using deals is that it enables highly targeted marketing campaigns for testing user experiments in a narrowly defined market. From a technical perspective, using open banking APIs including data pulled from third party banking technology or pushed directly from a bank via their open banking API), the system 10 is notified of the purchase details of its users. The characteristics of the transaction data transmitted to the system 10 would at least include: purchase amount, purchase date, bank description, card/bank account details used for the purchase, and merchant identifiers. The system 10 receives the transaction data on a scheduled basis, for example, a 24 hour delay (if pulled) or instantaneous (if pushed). In real-time or almost real-time when the system 10 receives the transaction data, the system 10 stores the transaction data in a separate database for post processing and data analysis to identify and retrieve specific details to enable the automated and intelligent assignment of cryptographic tokens to users.

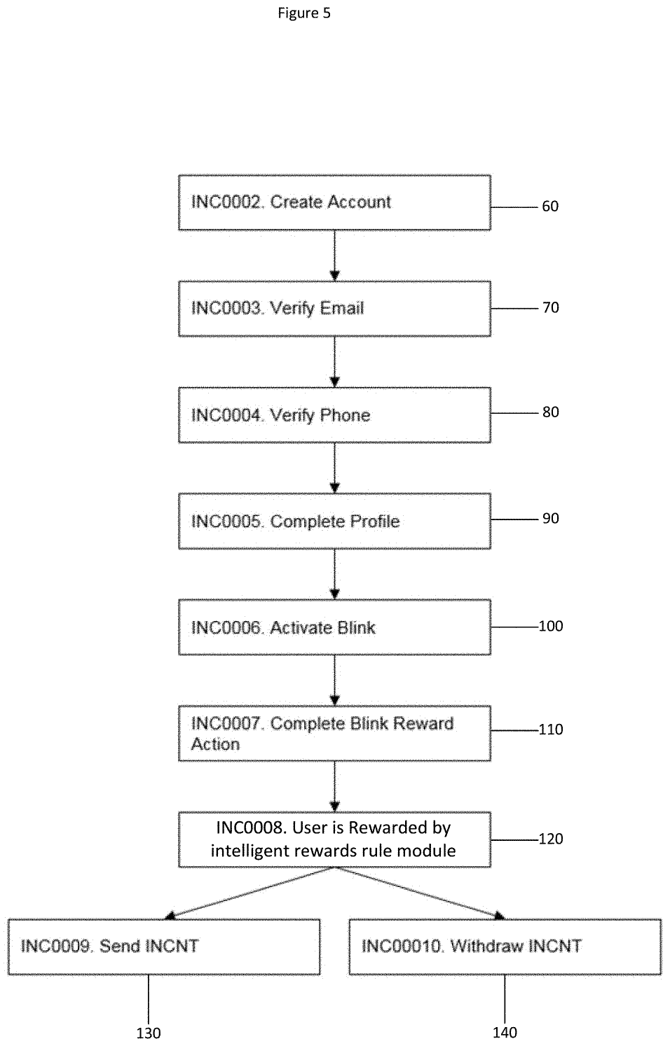

Referring to FIG. 5, the typical user journey joining and interacting with the system 10 is depicted in a process flow diagram. The main steps are: create user account 60, verify user's identify by verifying user's e-mail 70 and user's phone 80, completion of the user's profile 90, activation 100 of permanent or semi-permanent data integration between server 17 of the rewards provider and the user's financial institution's server 12, the user performing 110 a purchase transaction, the user receiving cryptocurrency associated with their eligible purchase transaction in accordance with processing by an intelligent rewards rule module 16, and the option of transferring 130 cryptocurrency from the user's cryptocurrency wallet address to another user or withdrawing 140 cryptocurrency from the user's cryptocurrency wallet address into fiat currency into their nominated bank account.

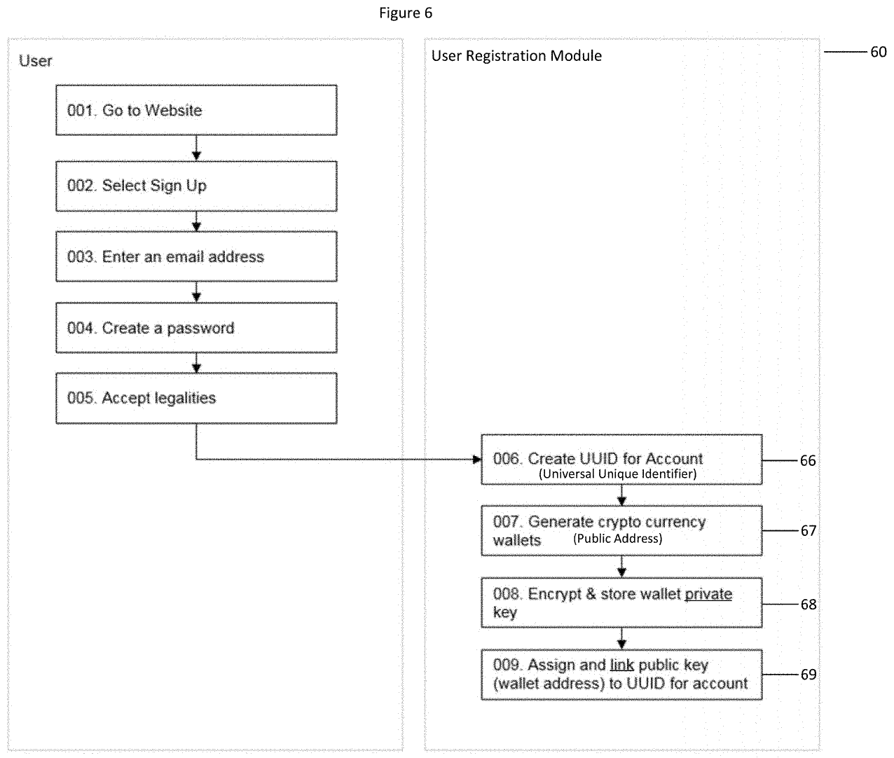

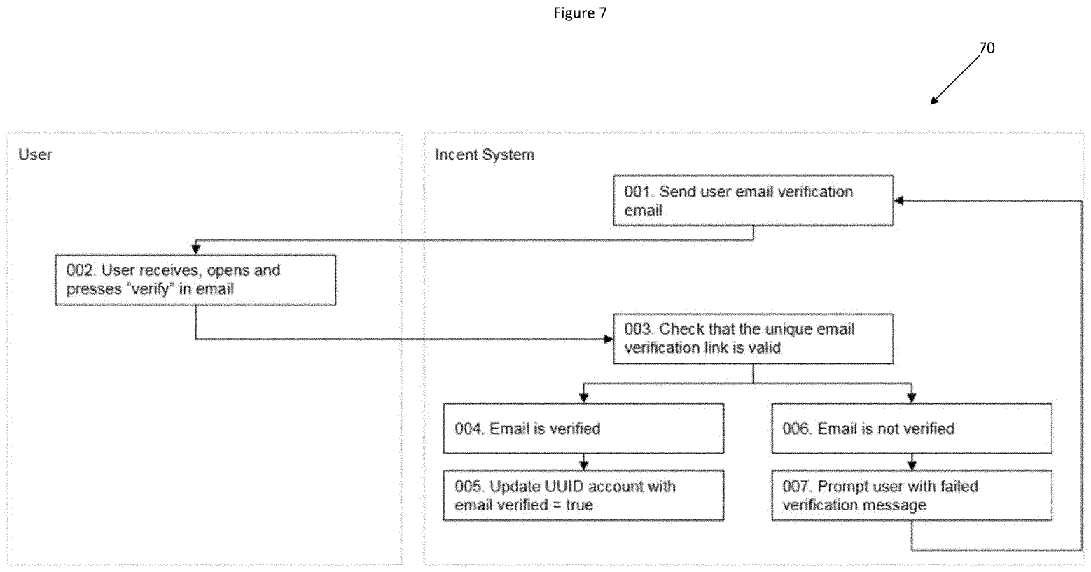

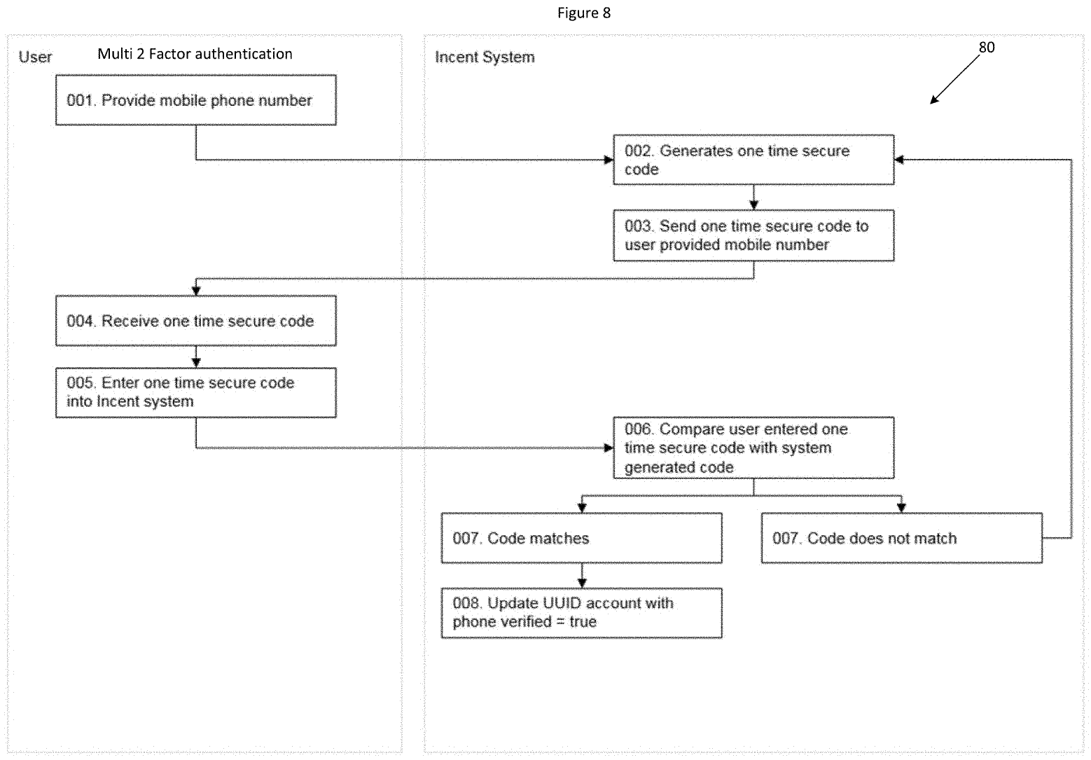

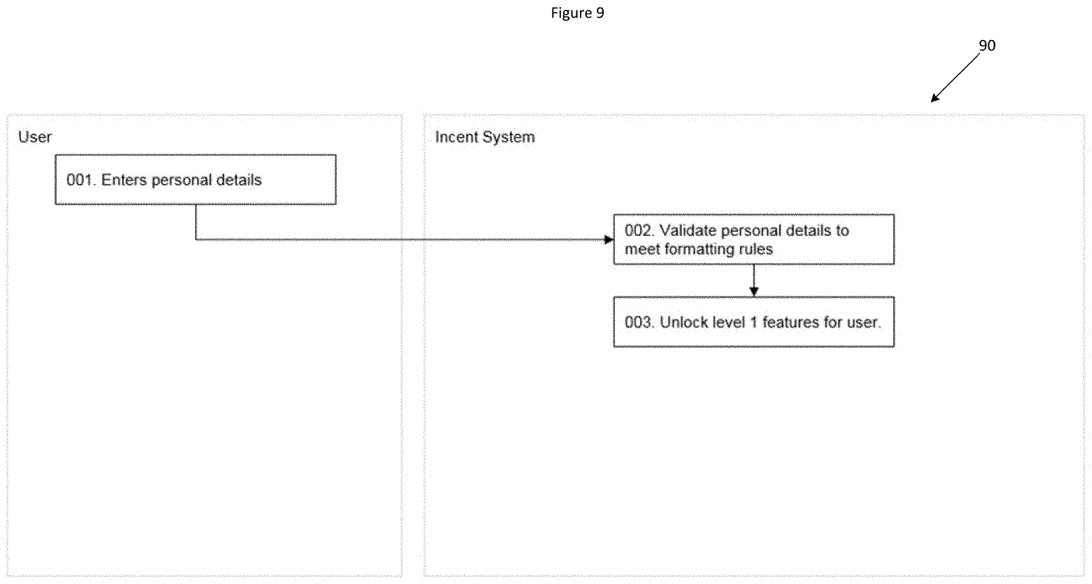

Referring to FIGS. 6 to 9, a secure user registration process 60 to register a user with the system 10 is depicted. A user 9 visits the website of the rewards provider to create a user account in the system 10. The user's entered e-mail address is verified by sending an e-mail to the user's entered e-mail address that includes a one-time security code or a URL link with a parameter containing the one-time security code. The user clicks the included URL link or inputs the code on the web page to verify their e-mail address. A similar process is performed for verifying the user's entered mobile phone number but instead of an e-mail, a SMS message is sent with the one-time security code. The user 9 must enter a password they wish to use.

A user registration module 60 of the system 10 generates a UUID 66 associated with the newly registered user account. The user registration module 60 also generates a cryptocurrency wallet 67 for the user and indicates the public address of the cryptocurrency wallet 67 to the user. The private key of the cryptocurrency wallet 67 is encrypted and stored 68 by the system 10. The public address of the cryptocurrency wallet 67 is assigned to and linked with the UUID 66 of the user account.

The system 10 uses information provided directly from the user's bank account. The system 10 is permitted access to transaction data from the user's bank account that the user has provided permission to view, and only relevant data is selectively retrieved. In another example, all data is non-discriminately retrieved and post-processing rules are applied by a post-processing software module to obtain relevant data to enable the automated and intelligent assignment of cryptographic tokens to users. The transaction analysis and matching module 15 is an autonomous program, and is configured to execute an automated task of analysing the transaction data to identify matches of transactions conducted with merchants registered with the system 10. The transaction analysis and matching module 15 may be self-configurable meaning that it can adapt its matching rules based on statistical analysis of large amounts of historical data if a trend is identified, for example, a merchant's name has been slightly changed or a new outlet of the merchant is partially included in the transaction data.

The transaction analysis and matching module 15 applies a series of post processing tasks. The post processing tasks include: an initial regular expression (regex) data parsing to filter out known string patterns that are of no use, and only capture known string patterns that are useful. The initial regex uses a set of pattern algorithms that find patterns within the bank transaction description to determine the statistical likelihood that a certain bank transaction string is associated with a certain merchant.

Next, a secondary regex data parsing task is performed. The secondary regex data parsing task has a set of pattern algorithms that look through the metadata fields of the bank transaction to find string patterns unique to each individual merchant.

Next, a trained machine learning model performs inferencing on the transaction data. The trained model is trained using original manually labelled training data and the new processed transaction data and recursively updates the pattern algorithms to increase the accuracy and likelihood of regular expression pattern matching across both the bank description and the metadata attributes. The purpose of performing inferencing using a trained machine learning model is to continually improve the percentage accuracy for matching transactions. A threshold where the base accuracy rate is set at 90% is considered a match by the system 10.

Next, match analytics is performed by a match analytics software module. The match analytics software module determines a match is “highly probable” if the regular expression is matched to the data provided from the bank with a 99% match rate (as described earlier). A match is determined as “highly likely” if the regular expression is matched to the data provided from the bank with a 96% match rate. A match is determined “very likely” with a 90% match rate. All match rates below 90% causes the transaction data to be quarantined and moved to a staging area where a manual check needs to be completed by skilled operators. The manual check will require an operator to view the transaction data and allocate a match/no match result as confirmation. This result is recorded and input as manually classified training data for a training phase of the machine learning model which updates the trained model. The updated trained model has an increased the accuracy rate of the matching process for future inferencing.

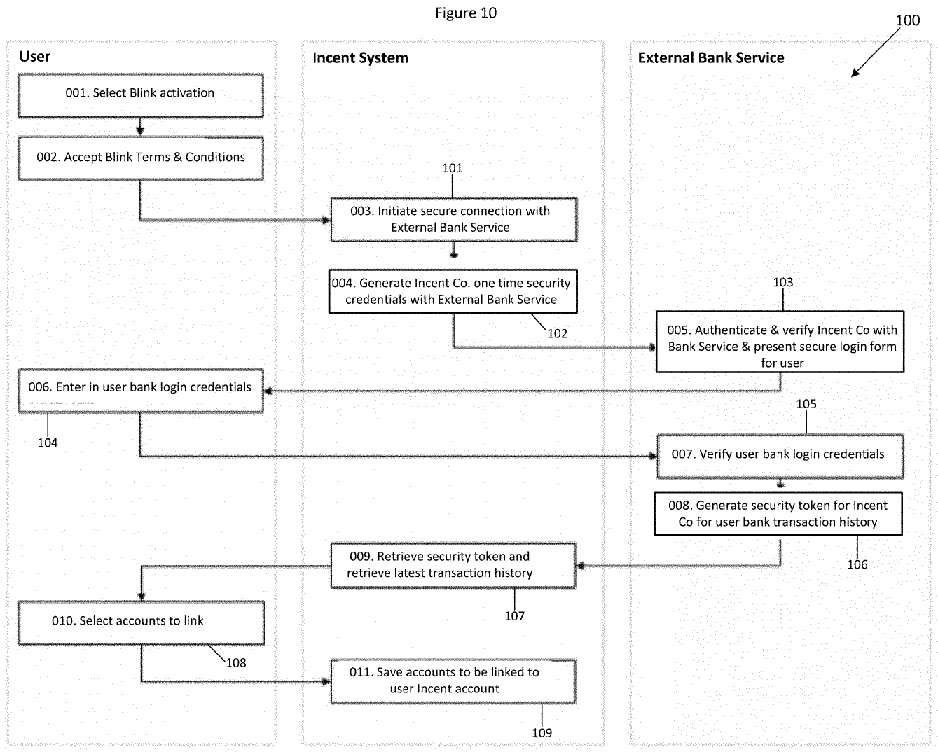

Referring to FIG. 10, integrating of a user's bank account to the system 10 via secure linking is illustrated. A user selects or interacts with a user interface component (i.e. a button) to indicate their intention to link their bank account with the system 10. A secure connection is established 101 with an external bank service using RESTful APIs. The system 10 generates 102 one-time security credentials with the external bank service. Using the one-time security credentials, the system 10 is authenticated and verified 103 by the external bank service. The user 9 is presented with a secure login page with an inline frame HTML element (i.e. iframe) which resembles their bank's login page and so is familiar to the user 9. The user 9 inputs 104 their bank login credentials in the iframe, it is securely transmitted via the Hyper Text Transfer Protocol Secure protocol to the external bank service for verification. After the user's inputted bank login credentials is verified 105 by the external bank service. The external bank service generates 106 a security token for the system 10 to access the transaction history data of the user. The transaction history data is retrieved 107 by the system 10 which may be pushed by the external bank service or pulled by the system 10. The user 9 indicates via selecting 108 the accounts that are displayed which are to be linked to the system 10. The system 10 saves the account identifiers of the accounts selected by the user 9 in the user's account with the system 10.

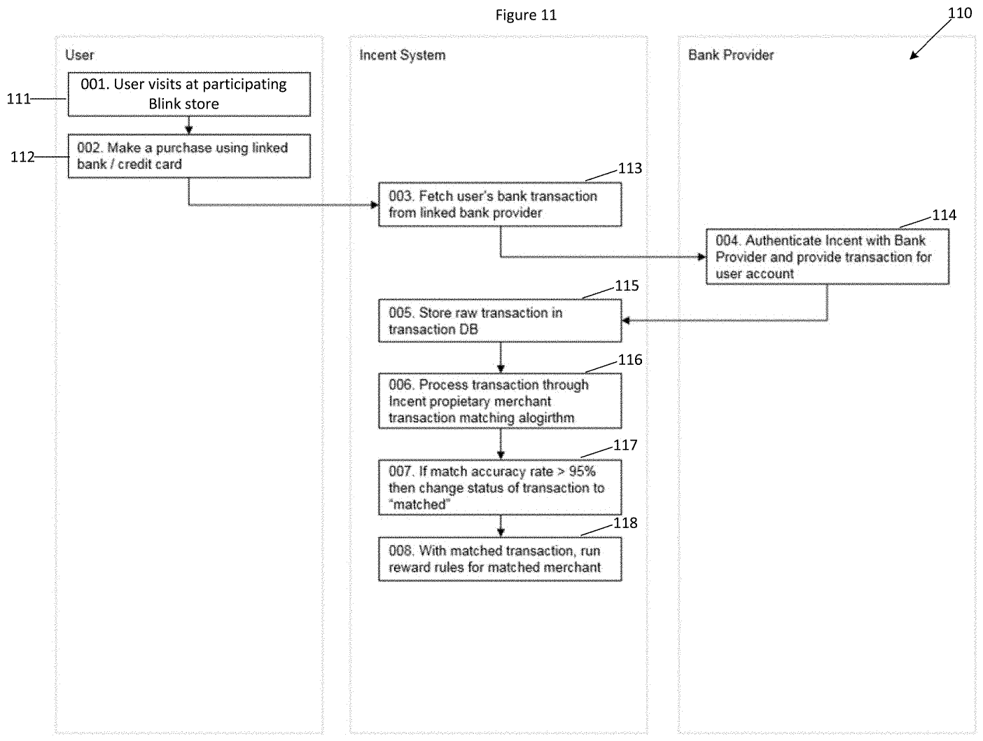

Referring to FIG. 11, a user purchase at a participating merchant and how the quantity of cryptocurrency is computed and transferred to the cryptocurrency wallet of the user, is illustrated. The user 9 visits 111 a participating merchant in the typical manner, either a physical store or online store. The user 9 makes a purchase 112 using their credit card or debit card that has been linked with the system 10. At a subsequent time, the transaction history data of the user's linked account is retrieved 113 via an API requiring authentication 114 of the system 10 with the external bank service. The transaction history data is provided in raw/unstructured form and is stored in the transaction database 14. The transaction history data is analysed and processed by a transaction analysis and matching module 15 by applying one or more matching rules to identify eligible purchase transactions by a user at participating merchants from the retrieved transaction data. Text strings in the transaction data which matches or partially matches with a high probability (e.g. greater than 95% match) to a merchant details stored in a merchant database table causes the data record for that transaction to have the transaction status data field changed to “matched”. The database executes a filter to only process data records with “matched” in the transaction status data field.

The rewards rule module 16 applies a selected reward rule on each of filtered data records and computes an amount of cryptocurrency to be transferred to the user's cryptocurrency wallet address against each of those data records. The total amount of cryptocurrency is calculated by a summing function and this total amount of cryptocurrency is transferred from the reward provider's cryptocurrency wallet address to the user's cryptocurrency wallet address. For each of the merchants, cryptocurrency is transferred from their cryptocurrency wallet address to the reward provider's cryptocurrency wallet address. Alternatively, rather than sending a total amount, there is a direct transfer of each cryptocurrency amount from the merchant's cryptocurrency wallet address to the user's cryptocurrency wallet address.

Many of the functional units described in this specification have been labeled as modules (or components), in order to more particularly emphasize their implementation independence. For example, a module may be implemented as a hardware circuit comprising custom VLSI circuits or gate arrays, off-the-shelf semiconductors such as logic chips, transistors, or other discrete components. A module may also be implemented in programmable hardware devices such as field programmable gate arrays (FPGAs), programmable array logic, programmable logic devices or the like.

Modules may also be implemented in software for execution by various types of processors. An identified module of program code may, for instance, comprise one or more physical or logical blocks of computer instructions which may, for instance, be organized as an object, procedure, or function. Nevertheless, the executables of an identified module need not be physically located together, but may comprise disparate instructions stored in different locations which, when joined logically together, comprise the module and achieve the stated purpose for the module.

A module of program code may be a single instruction, or many instructions, and may even be distributed over several different code segments, among different programs, and across several memory devices. Similarly, operational data may be identified and illustrated herein within modules, and may be embodied in any suitable form and organized within any suitable type of data structure. The operational data may be collected as a single data set, or may be distributed over different locations including over different storage devices, and may exist, at least partially, merely as electronic signals on a system or network. Where a module or portions of a module are implemented in software, the program code may be stored and/or propagated on in one or more computer readable medium(s).Unless specified to the contrary, any and all components herein described are understood to be capable of being manufactured and, as such, may be manufactured together or separately.

Moreover, in interpreting the disclosure, all terms should be interpreted in the broadest reasonable manner consistent with the context. In particular, the terms “comprises” and “comprising” should be interpreted as referring to elements, components, or steps in a non-exclusive manner, indicating that the referenced elements, components, or steps may be present, or utilized, or combined with other elements, components, or steps that are not expressly referenced.

The subject headings used in the detailed description are included only for the ease of reference of the reader and should not be used to limit the subject matter found throughout the disclosure or the claims. The subject headings should not be used in construing the scope of the claims or the claim limitations.

Although the technology herein has been described with reference to particular examples, it is to be understood that these examples are merely illustrative of the principles and applications of the technology. In some instances, the terminology and symbols may imply specific details that are not required to practice the technology. For example, although the terms “first” and “second” may be used, unless otherwise specified, they are not intended to indicate any order but may be utilised to distinguish between distinct elements.

It should be appreciated that while particular embodiments and variations of the invention have been described herein, further modifications and alternatives will be apparent to persons skilled in the relevant arts. In particular, the examples are offered by way of illustrating the principles of the invention, and to provide a number of specific methods and arrangements for putting those principles into effect.

Accordingly, the described embodiments should be understood as being provided by way of example, for the purpose of teaching the general features and principles of the invention, but should not be understood as limiting the scope of the invention, which is as defined in the appended claims.

1. A method comprising automatically assigning cryptographic tokens to cryptocurrency wallet addresses of users via a smart contract hosted on and executed by decentralised virtual machines of a decentralised network, comprising:
retrieving transaction history data for a linked account from a financial institution server using a stored security token to initiate a token-based authenticated session with the financial institution server, wherein the linked account is an account of a user associated with a cryptocurrency wallet address;
storing the received transaction history data in a transaction database;
analysing and matching purchase transactions in the stored transaction history data by calculating a matching accuracy score;
applying a predetermined reward rule on matching purchase transactions that have a calculated matching accuracy score above a predetermined matching threshold;
wherein the predetermined reward rule comprising:
calculating an amount of cryptographic tokens to be assigned at least based on an amount of the matching purchase transaction; and
assigning the calculated amount of cryptographic tokens to the cryptocurrency wallet address of the user via a blockchain transaction by digitally signing the blockchain transaction with a private key.

2. The method according to claim 1, wherein the linked account is initially linked by:
obtaining a first security token from a financial institution server having an account of the user;
initiating a secure connection with the financial institution server using the security token by generating a security credential;
generating a second security token from the financial institution server in response to the user inputting their login credentials for the financial institution server; and
storing the second security token.

3. The method according to claim 1, wherein the matching accuracy score is calculated by string matching a name of a merchant in the transaction history data with a record in database table of merchant names.

4. The method according to claim 1, wherein the matching accuracy score is calculated by applying a predetermined set of pattern algorithms over metadata fields of the transaction history data to find string patterns unique to individual merchants.

5. The method according to claim 1, wherein the matching accuracy score is calculated by performing inferencing on the transaction history data using a trained machine learning model performs, the trained model being trained using manually labelled training data and the transaction history data.

6. The method according to claim 5, wherein the matching accuracy score is calculated by performing match analytics to determine a classification of a match if a regular expression is matched to the transaction history data with a 99%, 96% or 90% match rate, and if the match is below 90%, the transaction history data is quarantined in a separate storage for a manual labelling by an operator, wherein manually labelled transaction history data is input as manually classified training data for a training phase of the machine learning model to update the trained model.

7. The method according to claim 1, wherein the predetermined matching threshold is 90%.

8. The method according to claim 1, wherein the predetermined reward rule further comprises a base amount of cryptographic tokens payable irrespective of the amount of the matching purchase transaction.

9. The method according to claim 8, wherein the predetermined reward rule further comprises a predetermined bonus amount of cryptographic tokens.

10. The method according to claim 9, wherein the predetermined reward rule further comprises a bonus amount predetermined by a merchant identified from the matching purchase transaction.
